(19) United States
(12) Patent Application Publication
(10) Pub. No.: US 2017/0118230 A1
(43) Pub. Date: Apr. 27, 2017

(54) COMMUNICATION SYSTEM, CONTROL DEVICE, AND CONTROL METHOD

(71) Applicant: HONDA MOTOR CO., LTD., Tokyo (JP)

(72) Inventor: Kazuyoshi WAKITA, Sakura-shi (JP)

(21) Appl. No.: 15/296,108

(22) Filed: Oct. 18, 2016

(30) Foreign Application Priority Data
Oct. 21, 2015 (JP) 2015-207267

(51) Int. Cl. H04L 29/06

(52) U.S. Cl. CPC H04L 63/1416; H04L 63/1483; H04L 63/1458

(57) ABSTRACT

A communication system includes: a transmission device configured to be connected to a network, wherein a message to be transmitted to the network, in a case where an own device is in a predetermined abnormality state, becomes a message in which a predetermined loss has occurred; and a reception device configured to be connected to the network and perform a predetermined failsafe processing when the predetermined loss has been detected in a message received from the network. The transmission device is configured to generate and transmit a message in which a predetermined loss has occurred similarly to the case where the own device is in the predetermined abnormality state when a fraudulent activity in the network has been detected.

### CROSS-REFERENCE TO RELATED APPLICATION

Priority is claimed on Japanese Patent Application No. 2015-207267, filed Oct. 21, 2015, the content of which is incorporated herein by reference.

### BACKGROUND OF THE INVENTION

Field of the Invention

The present invention relates to a communication system, a control device, and a control method.

Description of Related Art

Recently, there is a communication system in which a plurality of control devices provided in a vehicle communicate with each other over a network in the vehicle and control various functions in the vehicle. A technology for reducing an influence of fraudulent activity when fraudulent activity is performed in the network in such a communication system is known (for example, see Japanese Unexamined Patent Application, First Publication No. 2014-11621 (hereinafter, Patent Document 1)).

Patent Document 1 discloses detecting the presence of spoofing and notifying of the presence of spoofing using a message indicating the presence of spoofing in a CAN communication system including a communication channel, and a plurality of ECUs connected to the communication channel.

### SUMMARY OF THE INVENTION

However, according to Patent Document 1, in order to receive a notification of the presence of spoofing, a message indicating the presence of spoofing is transmitted, and the transmitted message is received and read. In such a method, there is a problem in that, it is necessary to add a new process of transmitting and receiving a message indicating fraudulent activity in a case where each control device is protected from fraudulent activity in the network, and a process of a device connected to the network becomes complicated.

An aspect according to the present invention has been made in view of such circumstances, and an object of the present invention provides a communication system capable of protecting a control device from fraudulent activity in a network using a simple configuration, a control device, and a communication control method.

To achieve the above object, the present invention adopts the following aspects. (1) A communication system according to an aspect of the present invention includes a transmission device configured to be connected to a network, wherein a message to be transmitted to the network, in a case where an own device is in a predetermined abnormality state, becomes a message in which a predetermined loss has occurred; and a reception device configured to be connected to the network and perform a predetermined failsafe processing when the predetermined loss has been detected in a message received from the network, and the transmission device is configured to generate and transmit a message in which a predetermined loss has occurred similarly to the case where the own device is in the predetermined abnormality state when a fraudulent activity in the network has been detected.

According to the aspect (1), the communication system includes the transmission device and the reception device which are connected to the network. The transmission device causes the predetermined loss to occur in the message to be transmitted to the network in the case where the own device is in the predetermined abnormality state. The reception device performs the predetermined failsafe processing when the predetermined loss has been detected in the message received from the network. The transmission device generates and transmits a message in which a predetermined loss has occurred similarly to the case where the own device is in the predetermined abnormality state when the fraudulent activity in the network has been detected.

(2) In the aspect (1), the transmission device may be configured to detect that a device spoofing the own device is connected to the network as the fraudulent activity in the network.

(3) In the aspect (1) or (2), the transmission device may be configured to detect that a message, to which an identifier indicating that the own device is a transmission source is added, is transmitted from another device, and to determine that the fraudulent activity in the network has been detected.

(4) In the aspect (1), the transmission device may be configured to detect a DoS attack in the network as the fraudulent activity in the network.

(5) In the aspect (1), the transmission device may be configured to detect a fraudulent access to the network as the fraudulent activity in the network.

(6) In any one of the aspects (1) to (5), the transmission device may be configured to set information for detecting a transmission error of the message to be transmitted to a value different from a legitimate value to generate the message in which the predetermined loss has occurred.

(7) In any one of the aspects (1) to (5), the transmission device may be configured to set information indicating that information to be transmitted by the message to be transmitted is updated to a value different from a legitimate value to generate the message in which the predetermined loss has occurred.

(8) In any one of the aspects (1) to (7), the reception device may be configured not to receive a message during a predetermined time after the predetermined loss has been detected in a message from the transmission device.

(9) In any one of the aspects (1) to (7), in a case where the reception device receives a message including an identifier indicating a transmission source as same as a transmission source of a message in which the predetermined loss has been detected during a predetermined time after the predetermined loss has been detected in the message from the transmission device, the reception device may be configured not to use information included in the received message in a process in the reception device.

(10) A control device according to one aspect of the present invention is a control device that is configured to transmit a message to a reception device configured to perform a predetermined failsafe processing when a predetermined loss has been detected in a message received from a network, the control device including a control unit configured to be connected to the network, wherein a message to be transmitted to the network, in a case where an own device is in a predetermined abnormality state, becomes a message in which a predetermined loss has occurred, and generate and transmit a message in which a predetermined loss has occurred similarly to the case where the own device is in the predetermined abnormality state when a fraudulent activity in the network has been detected.

(11) A control method according to an embodiment of the present invention is a method of controlling a communication system including a transmission device configured to be connected to a network, a message to be transmitted to the network, in a case where an own device is in a predetermined abnormality state, becomes a message in which a predetermined loss has occurred, and a reception device configured to be connected to the network and perform a predetermined failsafe processing when the predetermined loss has been detected in a message received from the network, the method including a process of generating and transmitting a message in which a predetermined loss has occurred similarly to the case where the own device is in the predetermined abnormality state when a fraudulent activity in the network has been detected.

According to the aspect of the present invention, the communication system includes the transmission device configured to be connected to the network, the message to be transmitted to the network, in the case where the own device is in the predetermined abnormality state, becoming a message in which the predetermined loss has occurred; and the reception device configured to be connected to the network and perform the predetermined failsafe processing when the predetermined loss has been detected in the message received from the network, and the transmission device generates and transmits the message in which a predetermined loss has occurred similarly to the case where the own device is in the predetermined abnormality state when the fraudulent activity in the network has been detected. Thus, it is possible to protect the control device from fraudulent activities in the network with a simpler configuration.

### BRIEF DESCRIPTION OF THE DRAWINGS

FIG. 1 is a diagram illustrating a configuration of a vehicle communication system 1 of an embodiment.

FIG. 2 is a diagram illustrating an example of a configuration of an ECU 10.

FIG. 3 is an example of a format of a frame F that the ECU 10 transmits to a bus 2.

FIG. 4 is a flowchart illustrating an overview of a reception process in the ECU 10.

FIG. 5 is a diagram illustrating an example of a determination process of detecting that a loss of information has occurred.

FIG. 6 is a sequence diagram illustrating an operation of a vehicle communication system in a case where fraudulent activity is not detected in a network NW (Part 1).

FIG. 7 is a sequence diagram illustrating an operation of a vehicle communication system in a case where fraudulent activity is not detected in the network NW (Part 2).

FIG. 8 is a diagram illustrating an operation of a vehicle communication system of a comparative example.

FIG. 9 is a diagram illustrating a configuration of an ECU 10-1 of an embodiment.

FIG. 10 is a flowchart illustrating an overview of a process that the ECU 10-1 performs when detecting fraudulent activity.

FIG. 11 is a sequence diagram illustrating an operation of the vehicle communication system 1 when spoofing has been performed.

FIG. 12 is a sequence diagram illustrating an operation of the vehicle communication system 1 when spoofing has been performed.

FIG. 13 is a sequence diagram illustrating an operation of a vehicle communication system 1A in a case where a DoS is performed in the network NW.

FIG. 14 is a sequence diagram illustrating an operation of the vehicle communication system 1B in a case where fraudulent activity is performed.

### DETAILED DESCRIPTION OF THE INVENTION

Hereinafter, an embodiment of a communication system, a control device, and a control method of the present invention will be described with reference to the drawings.

### First Embodiment

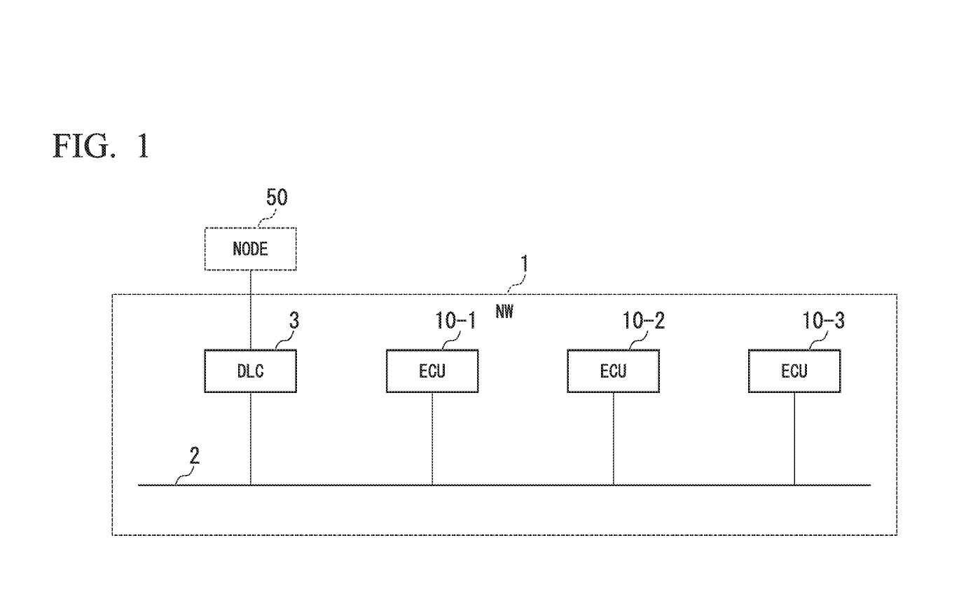

FIG. 1 is a diagram illustrating a configuration of a vehicle communication system 1 (a communication system) of this embodiment.

The vehicle communication system 1 is mounted on, for example, a vehicle. The vehicle communication system 1 constitutes a network NW at least in a vehicle. In the network NW, for example, communication based on a controller area network (CAN) is performed via a bus 2.

The vehicle communication system 1 includes ECUs 10-1 to 10-3 connected to the bus 2. Hereinafter, when the ECUs 10-1 to 10-3 are not distinguished from each other, the ECUs 10-1 to 10-3 are simply referred to as an ECU 10. The bus 2 is, for example, a twisted pair cable and transfers a signal using a differential voltage scheme. Although devices such as the ECUs 10-1 to 10-3 are described as being commonly connected to the bus 2, the devices may be connected to different buses which are connected to be able to communicate with each other by, for example, a relay device (not illustrated).

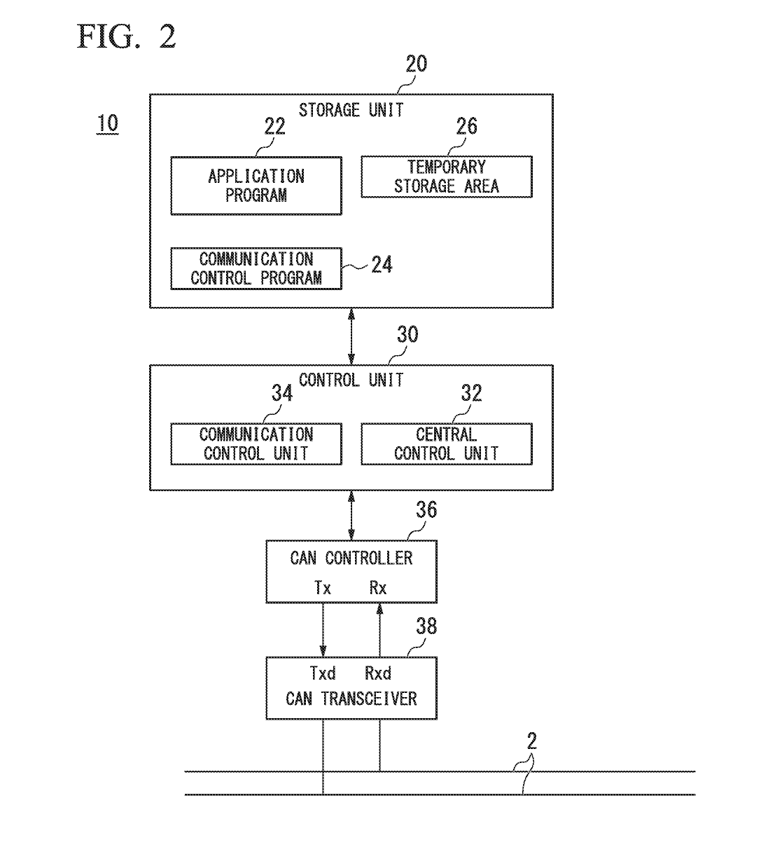

The ECU 10 includes, for example, an engine ECU that controls an engine or a seat belt ECU that controls a seat belt. The ECU 10 receives a frame that is transmitted to the network NW to which an own device belongs. Hereinafter, each frame transmitted to the network NW is referred to as a frame F. The frame F is identified by an identifier (hereinafter referred to as an ID) added to the frame. The ECU 10 stores an ID for identifying the frame F related to the own ECU 10 (hereinafter referred to as a registration ID) from among the received frames F in a storage unit 20 (FIG. 2) by referring to the ID added to the received frame F (hereinafter referred to as a reception ID), and extracts and acquires the frame to which a reception ID having the same value as that of the registration ID has been added. Further, the ECU 10 transmits a frame to the bus 2 according to a preset priority, for example, on the condition that a frame F including a reception ID having the same value as a registration ID of the own ECU 10 is received.

A DLC 3 to which an external device such as a verification device is connected is provided in the network NW. The DLC 3 has a connection terminal for communication with an external device. The verification device or the like connected to the DLC 3 at a time of checking whether a vehicle communicates with the ECU 10 connected to the bus 2, and checks and verifies a state of the vehicle communication system 1. Except for the time of checking the vehicle, the vehicle communication system 1 can be made to function without connecting the verification device or the like to the DLC 3.

A priority is set in each frame F to be transmitted to the network NW, and priority control is performed in the vehicle communication system 1 so that the frame F having a higher priority is transmitted first.

FIG. 2 is a diagram illustrating a configuration example of the ECU 10. The ECU 10 includes, for example, the storage unit 20, a control unit 30, a CAN controller 36, and a CAN transceiver 38. The control unit 30 includes, for example, a processor such as a central processing unit (CPU).

The storage unit 20 is realized by, for example, a nonvolatile storage device such as a read only memory (ROM), an electrically erasable and programmable read only memory (EEPROM), or a hard disk drive (HDD), and a volatile storage device such as a random access memory (RAM) or a register. The storage unit 20 stores a program such as an application program 22 or a communication control program 24, and various types of information referenced by the program. The storage unit 20 includes a temporary storage area 26 including a transmission buffer (not illustrated) and a reception buffer (not illustrated). Further, the storage unit 20 stores, for example, an ID table in which an ID of the frame F that is transmitted or received over the network NW is stored, as various types of information. For example, the ID of the frame F includes information indicating a transmission source, a destination, a type of frame F, and the like. More specifically, an ID of a frame F to be received by the ECU 10-1 and an ID of a frame F to be transmitted by the ECU 10-1 are included in the ID table. Further, priority information that is information indicating a transmission schedule of a frame F to be transmitted to the network NW and a priority of the frame F is stored in the storage unit 20.

The application program 22 is a program for performing each information process assigned to the ECU 10. The communication control program 24 is a program for controlling the CAN controller 36 according to an instruction from the application program 22 to cause the CAN controller 36 to perform a communication process and to acquire a result of the communication process related to the communication via the CAN controller 36 as management information. The communication control program 24 may be configured to include a control program that is executed by the CAN controller 36 itself, or may be configured not to include the control program that is executed by the CAN controller 36 itself if the CAN controller 36 itself has the control program that is executed by the CAN controller 36 itself. The following description, a case where the communication control program 24 is configured to include the control program of the CAN controller 36 will be illustrated.

The control unit 30 includes a central control unit 32, and a communication control unit 34. The central control unit 32 performs a function by the application program 22 being executed and executes control provided to the ECU 10.

The communication control unit 34 performs a function by the communication control program 24 being executed and executes a communication process of the ECU 10 under the control of the central control unit 32. The communication control unit 34 determines whether the received frame F is a frame F in which information used by the central control unit 32 of the own device is included by referring to a reception ID of the frame F received through the CAN transceiver 38 and a registration ID stored in in the ID table. An ID (a registration reception ID) of the frame F to be received by the ECU 10-1 and an ID (a registration transmission ID) of a frame F to be transmitted by the ECU 10-1 are included in the registration ID stored in the ID table. The communication control unit 34 uses, for example, the registration reception ID in the ID table when performing the above determination.

If the information used by the own ECU 10 is included in the frame F, the communication control unit 34 acquires information included in the frame F and stores the information in the temporary storage area 26 of the storage unit 20. On the other hand, if the information used by the own ECU 10 is not included in the frame F, the communication control unit 34 performs control, for example, so that the information included in the frame F is discarded.

A message from the ECU 10 on the transmission side may be included in the frame F received through the CAN transceiver 38. The communication control unit 34 detects that a predetermined loss has occurred in at least a portion of information constituting the frame F, such as a portion including a message from the ECU 10 on the transmission side. When the communication control unit 34 detects that the predetermined loss has occurred, the communication control unit 34 performs control so that failsafe processing in the ECU 10 is performed. The failsafe processing in the ECU 10 is a process that the ECU 10 detecting an abnormality performs to reduce an influence on a travel of the vehicle and maintain a control state of the vehicle as a safe state.

As the failsafe processing in the ECU 10, for example, the communication control unit 34 performs control so that at least a new frame F is not received during at least a predetermined time after the predetermined loss has been detected. The frame F prevented from being received by the communication control unit 34 may be limited to a frame F with an ID indicating a transmission source added to the frame F for which the predetermined loss has been detected to have occurred. As described above, the ECU 10 can limit reception of information from the ECU 10 that is likely to fail by, for example, limiting the frame F to be received through the failsafe processing. Further, details of the predetermined loss that is a determination condition in the communication control unit 34 will be described below

The communication control unit 34 causes the CAN controller 36 to transmit the frame F from the CAN transceiver 38. For example, the communication control unit 34 transmits the frame F (a request frame) to which an ID indicating that the own device transmits the frame F is added to the bus 2, and transmits a frame F (a response frame) including an ID indicating that the own device performs transmission to the bus 2 when receiving a transmitted request frame.

The CAN controller 36 transmits and receives various frames F to and from the bus 2 via the CAN transceiver 38. When the CAN controller 36 transmits the frame F to the bus 2, the CAN controller 36 converts the frame F stored in the transmission buffer of the temporary storage area 26 into a serial transmission signal, for example, using a Non-Return-to-Zero (NRZ) scheme, and outputs the serial transmission signal to the CAN transceiver 38. The CAN controller 36 outputs a voltage at a logic level Low at a bit at which the signal after conversion is “0” (dominant) and a voltage at a logic level High at a bit at which the signal is “1” (recessive). Further, when the CAN controller 36 receives the frame F from the CAN transceiver 38, the CAN controller 36 extracts the frame F from the reception signal supplied from the CAN transceiver 38 and stores the extracted frame F in the reception buffer of the temporary storage area 26. The CAN controller 36 includes an error detection processing unit (not illustrated) that executes an error detection process on the frame F. When the error detection unit transmits the frame F, the error detection unit generates a predetermined error detection code that is included in a portion of the frame F and transmitted. When the error detection processing unit receives the frame F, the error detection processing unit outputs a result of detecting the error detection information included in the portion of the frame F.

The CAN transceiver 38 functions as a transmission unit that transmits a frame F or a reception unit that receives a frame F. When the CAN transceiver 38 transmits the frame F to the bus 2, the CAN transceiver 38 generates a differential voltage according to a logic state of the transmission signal acquired from the CAN controller 36 and outputs the differential voltage to the bus 2. Further, when the CAN transceiver 38 acquires a frame F from the bus 2, the CAN transceiver 38 generates a reception signal shaped to be included in a predetermined voltage range from a differential voltage on the bus 2 and transmits the reception signal to the CAN controller 36. The CAN controller 36 extracts the frame F from the signal from the CAN transceiver 38 and stores the frame F in the storage unit 20.

As shown above, each ECU 10 has a common configuration for the above communication process.

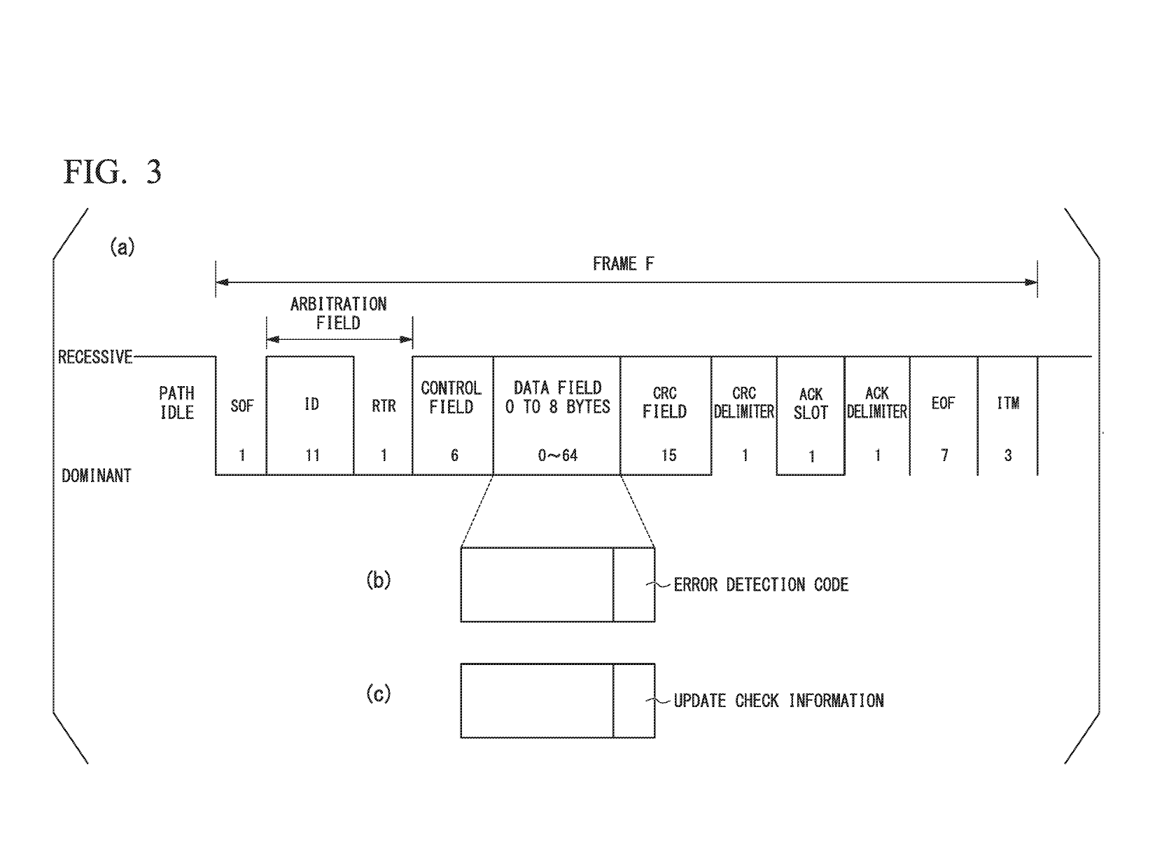

FIG. 3 is a format example of a frame F that the ECU 10 transmits to the bus 2. In FIG. 3(a), a frame F to be transmitted in a single transmission is illustrated. The frame F includes, for example, a start of frame (SOF) indicating a start of the frame F, an arbitration field including a remote transmission request (RTR) for identifying an ID of the frame F, the frame F, and a remote frame, a control field indicating, for example, the number of bytes of the frame F, a data field that is an entity of the frame F to be transferred, a CRC field to which an error detection code (CRC) for detecting an error of the frame F is added, an ACK slot via which a notification (ACK) is received from a unit that has received a correct frame F, an ACK delimiter, and end of frame (EOF) indicating an end of the frame F.

The ECU 10 assigns user data at a predetermined position in a data field of the frame F and performs communication. The data field may include management information for verifying a degree of reliability of the user data in addition to the user data. The management information for verifying the degree of reliability may include, for example, error check information for checking an error of user data in a single frame F or user data in which a plurality of frames F are collected, and update check information for checking that a value of the data field is updated.

In FIG. 3(b), an example in which the error check information is assigned to the data field is illustrated. The error check information includes, for example, a SUM value (a check sum) or an error detection code such as a parity. In FIG. 3(c), an example in which the update check information for checking that the value of the data field is updated is assigned to the data field is illustrated. Information that changes each time a frame F is transmitted is included in the update check information. The information that changes each time a frame F is transmitted may be an alive counter indicating a value corresponding to the number of times the frame F is transmitted.

According to one example of the frame F, the ECU 10 may include the management information for verifying a degree of reliability of the user data and user data corresponding thereto in a single same frame F and transmit the frame F or may distribute the management information and the user data into a plurality of frames F and transmit the plurality of frames F. The assignment of the management information and the user data to data fields is arbitrary and, for example, is assumed to be determined in advance. In the following description, the frame F, the user data assigned to the frame F, and the management information for verifying the degree of reliability of the user data are collectively referred to as a message.

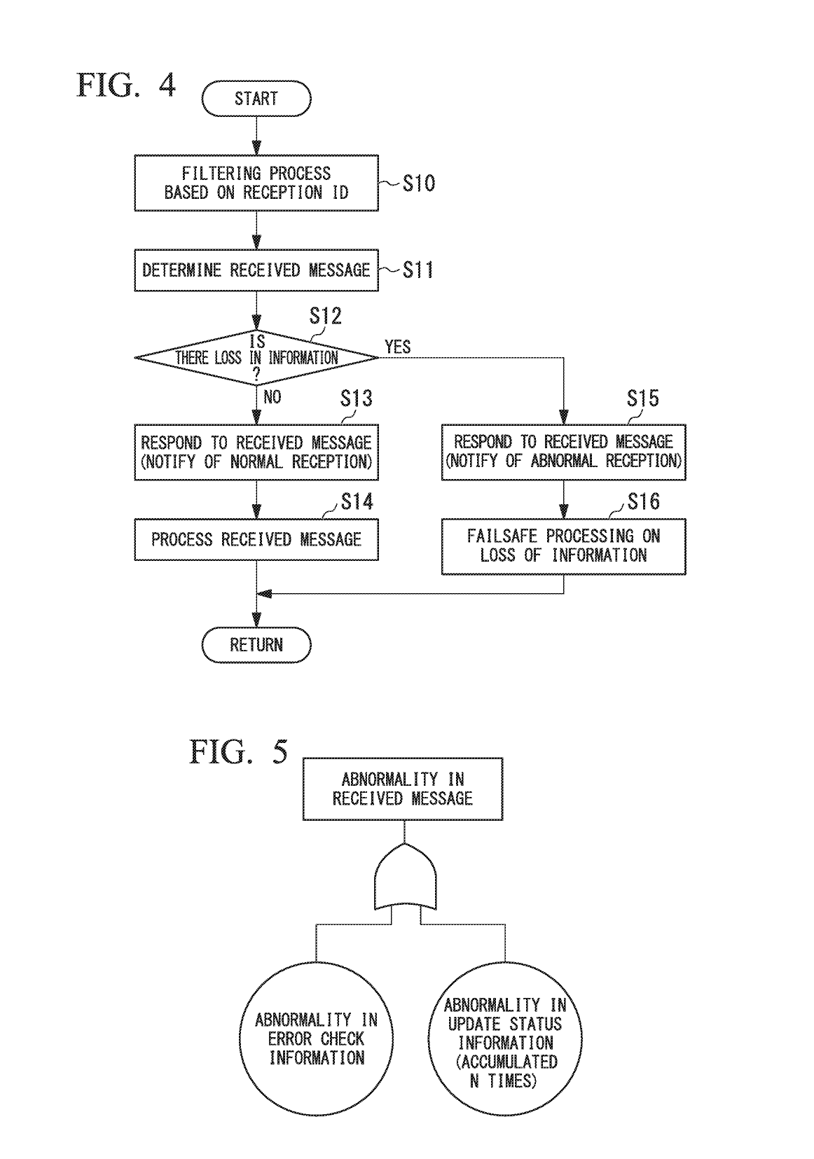

A process of the vehicle communication system will be described with reference to FIGS. 4 to 7. The process illustrated in FIGS. 4 to 7 is a process indicating a case where particular fraudulent activity (also referred to as fraudulent activity) in the network NW is not performed in this embodiment.

FIG. 4 is a flowchart illustrating an overview of a reception process in the ECU 10. The communication control unit 34 performs predetermined failsafe processing according to the following procedure when the predetermined loss has been detected in a message received from the network NW through the reception process in the ECU 10.

The communication control unit 34 performs a filtering process on a received message by referring to the reception ID added to the frame F of the message (received message) received by the CAN transceiver 38 (S10). The filtering process performed by the communication control unit 34 includes a process of collating the reception ID with the registration reception ID of the ID table stored in the storage unit 20 and determining whether the frame F is a frame F including information to be used by the own ECU 10. When the registration reception ID having the same value as that of the reception ID is included in the ID table, the communication control unit 34 extracts the frame F to which the reception ID matching the registration reception ID has been added, as a received message and stores the frame F in the temporary storage area 26 of the storage unit 20.

Next, the communication control unit 34 performs a determination process in which the received message extracted through the filtering process in S10 is a determination target (S11). Details of the determination process will be described below.

Next, the communication control unit 34 determines whether there is a loss in information for the received message which is the determination target on the basis of the result of the determination in S11 (S12). If it is determined that there is no loss in the information on the basis of the result of the determination in S12 (S12: No), the communication control unit 34 notifies that the received message has been normally received (a normal reception) in a process of performing a response to the received message that is a target of the determination process in S11 (S13). The central control unit 32 performs a process of a matter instructed by the received message (S14).

On the other hand, if it is determined that there is a loss in the information on the basis of the result of the determination in S12 (S12: Yes), the communication control unit 34 notifies that an abnormality has been detected at a time of reception of the received message (all abnormal reception) in the process of performing a response to the received message that is a target of the determination process in S11 (S15). The central control unit 32 performs failsafe processing on the loss of information in the received message (S16).

In the following description, the ECU 10-1 is illustrated as being a device on the message transmission side, and the ECU 10-2 is illustrated as being a device on the message reception side.

### (Abnormality/Failure of ECU 10 and Notification Method Thereof)

Another ECU 10 is notified of an abnormality/failure of the ECU 10 using a method based on a loss of a message caused by an abnormality/failure as will be described below without the abnormality/failure being detected in the own device. The other ECU 10 receives the notification and detects an abnormality/failure of the ECU 10 that is a notification source. A type of abnormality/failure of the ECU 10 and a method of notifying of a detection result will be described by way of example. Although the abnormality/failure of the ECU 10 is not detected in the own device in this example, the same method as that in a detection method in the own device may be used.

### (1) Failure of Hardware of ECU 10 Serving as Transmission Device

For example, the ECU 10-1 is configured so that a loss of information occurs in any of the user data to be transmitted and the error check information due to a failure of hardware of the own device. That is, if the hardware of the ECU 10-1 fails, a loss of information occurs in any of the user data to be transmitted and the error check information, that is, a loss of regularity kept between the user data and the error check information occurs. The regularity kept between the user data and the error check information is, for example, regularity in which a sum value of a predetermined portion of a message and a value indicated by the error check information are the same. The ECU 10-1 uses information in which the loss occurs for notification of an abnormality/failure of the ECU 10-1. The ECU 10-2 having received the notification determines that an abnormality, that is, a failure of the hardware is likely to occur on the ECU 10-1 side on the basis of a result of an error detection of a message in which information loss or regularity loss has occurred.

### (2) Overload State of ECU 10 Serving as Transmission Device

For example, the process of the ECU 10 is overloaded due to an occurrence of any abnormality state in the network NW and the ECU 10 may be unable to transmit a legitimate message. When a process to be performed by the control unit 30 of the ECU 10-2 is overloaded, for example, the control unit 30 is unable to write the user data to be transmitted as a response message to the storage unit 20. As a result, the ECU 10-2 may be unable to transmit a legitimate response message in which information has been updated. For example, the ECU 10 includes information that changes each time a frame F is transmitted, that is, the update check information, in the frame F for transmitting the user data and transmits the frame F, but if such a situation occurs, regularity of the update check information indicating that the user data has been updated is disturbed, and a loss of regularity of the update check information of which the regularity is maintained occurs.

The regularity of the update check information indicating that the user data has been updated is, for example, regularity in which a predetermined value is added to a value indicated by the update check information each time the user data is updated. The ECU 10-2 uses the information in which the loss has occurred for notification of an abnormality/failure of the ECU 10-2. The ECU 10-1 that has received the notification detects a loss of information or a loss of regularity in the received message, and determines that an abnormality, that is, an overload state, is likely to occur on the ECU 10-2 side.

(Determination Process of Detecting that Loss of Information has Occurred)

The ECU 10 performs a determination process of detecting that a loss of information has occurred, for example, according to a determination rule illustrated in FIG. 5. FIG. 5 is a diagram illustrating an example of the determination process of detecting that a loss of information has occurred. The ECU 10 determines that there is an abnormality in a received message if the ECU 10 detects at least one of an abnormality in the error check information and an abnormality in the update check information.

For example, in a case where “(1) A failure of hardware of the ECU 10 serving as a transmission device” is detected, the ECU 10-2 performs a check in which the error check information for a message received from the ECU 10-1 as a target of the error detection process is included in a check target. The ECU 10-2 includes at least one of various types of error check information such as a CRC in the frame F of the message received from the ECU 10-1, and a SUM value or a parity imparted to the user data as error check information for a message in the check target.

The ECU 10-2 may select at least one of various types of error check information as a target of the error detection process to perform the above detection, or may combine multiple types of error check information to perform the above detection.

Further, for example, in a case where “(2) An overload state of the ECU 10 serving as a transmission device” is detected, the ECU 10-2 transmits a frame F to which information that changes each time a frame F is transmitted, that is, the update check information in which regularity is maintained, is imparted. The ECU 10-1 can detect that a loss has occurred in the regularity indicated by the update check information in which the regularity is maintained by detecting a regularity indicated by the update check information. The ECU 10-1 may detect an overload state of the ECU 10-1 from a result of the detection of the loss in the update check information in the response message.

For detection of the abnormality in the update check information, the ECU 10 may perform the detection according to protection steps at a time of abnormality detection to determine that an abnormality has occurred if N or more abnormality detections are accumulated in a predetermined period of time. Thus, the ECU 10 can perform a determination for detecting that a loss of information has occurred while preventing an excessive detection of an abnormality state by determining the protection steps.

### (Fail-Safe Processing)

As described above, the ECU 10 in this embodiment detects an abnormality state of the ECU 10 or receives a notification of an abnormality due to a loss of information or loss of regularity from the other ECU 10 and detects the abnormality of the ECU 10 in order to perform the failsafe processing. The ECU 10 that has detected that an abnormality has occurred or the ECU 10 that has received the notification of the abnormality of the other ECU 10 performs the failsafe processing so as to maintain at least a control state of the ECU 10 as the safe state. The failsafe processing in the ECU 10 includes failsafe processing common to the ECU 10 and failsafe processing determined in advance according to a type of function assigned to each ECU 10.

Hereinafter, failsafe processing that is commonly performed by each ECU 10 will be illustrated and described. Each ECU 10 performs failsafe processing according to the detected loss of information or regularity regardless of whether fraudulent activity in the network NW is performed.

When the ECU 10-2 detects the loss of information or the loss of regularity from the message received from the ECU 10-1, the ECU 10-2 performs failsafe processing according to a rule that control information (user data) or the like transmitted from the ECU 10-1 is not used for a process of the ECU 10-2. When such an ECU 10-2 receives a message including the control information, the ECU 10-2 may perform a predetermined process such as a process of canceling the reception of the message or discarding the control information included in the received message.

As described above, the ECU 10-2 does not use the received control information or the like for the process. However, when the process is performed, some information with which the control information is replaced is necessary. The ECU 10-2 may replace the control information or the like not used for the process with a standard value for performing a desired operation. In this case, the ECU 10-2 stores, for example, the standard value for performing a desired operation in the storage unit 20, and replaces a value indicated by the control information or the like included in the message with the standard value. The ECU 10-2 prepares the standard value as a provisional value with which the value indicated by the control information or the like is replaced in advance. Accordingly, the provisional value can be used, the safe state can be maintained, and a predetermined process can be performed.

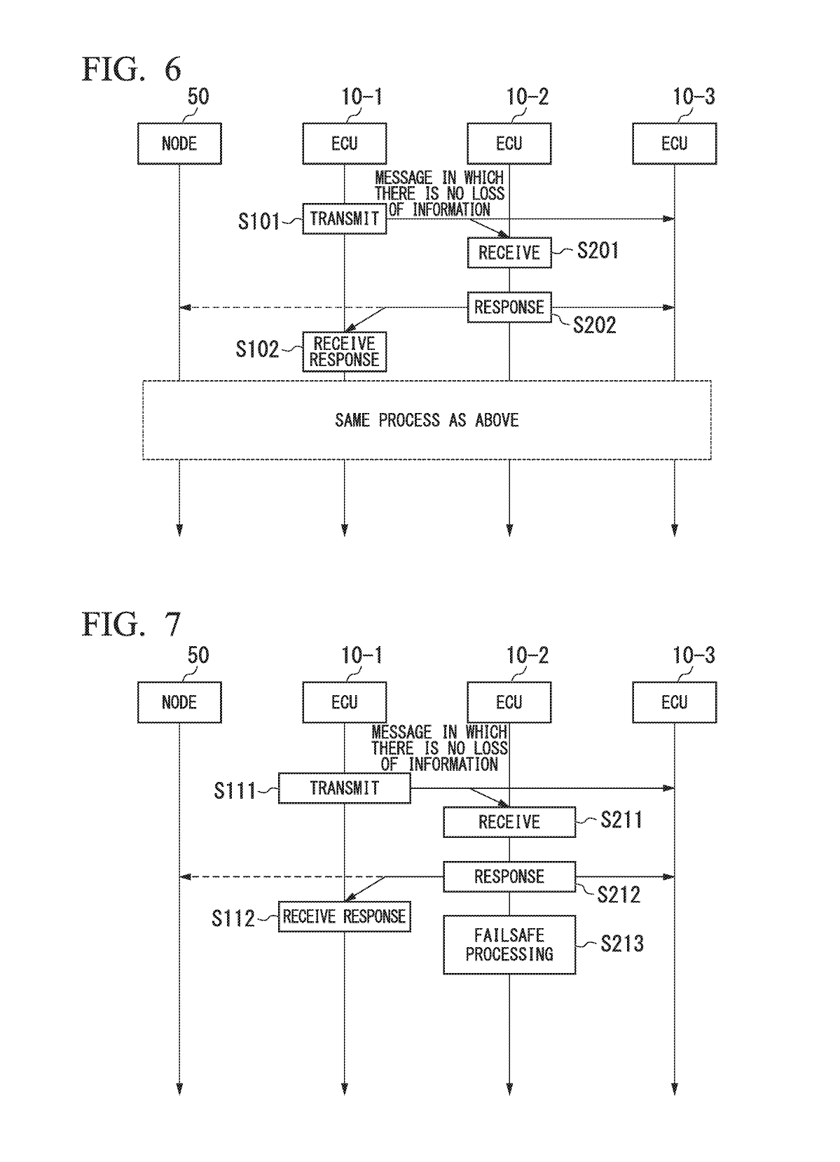

An operation of the ECU 10 that performs the above reception process will be described with reference to FIGS. 6 and 7. FIGS. 6 and 7 are sequence diagrams illustrating an operation of the vehicle communication system in a case where fraudulent activity is not detected in the network NW.

Each ECU 10 transmits a message including an ID for identifying, for example, an ECU that is a destination to the network NW (S101). For example, an ID of the message sent from the ECU 10-1 illustrated in FIG. 6 indicates that the message is a message addressed to the ECU 10-2.

Next, the ECU 10-2 receives the message transmitted from the ECU 10-1 (S201) and transmits a response message corresponding to the received message to the network NW (S202). The ECU 10-2 performs a determination as to whether information indicating an abnormality is included in the received message. The ECU 10-2 detects that there is no loss of information or loss of regularity in the received message as a result of the determination. Accordingly, the ECU 10-2 determines that at least the ECU 10-1 operates normally, and does not perform failsafe processing as a process of the ECU 10-2.

Then, the ECU 10-1 receives the response message from the ECU 10-2 (S102). Accordingly, the ECU 10-1 can detect that the ECU 10-2 is able to receive the message normally.

As described above, in a series of steps from S101 to S102, the transmission of the message from the ECU 10-1 to ECU 10-2 is completed. Further, it is possible to repeat the transmission of the message from the ECU 10-1 to the ECU 10-2 by repeating the series of sequences from S101 to S102 described above.

On the other hand, if the ECU 10-1 transmits a message to the network NW in a case where the ECU 10-1 is in a predetermined abnormality state as illustrated in FIG. 7, the predetermined loss occurs in the message (S111).

Then, the ECU 10-2 receives the message transmitted from the ECU 10-1 (S211) and transmits a response message corresponding to the received message to the network NW (S212). Further, the ECU 10-2 performs a determination as to whether there is a loss of information or a loss of regularity in the received message. The ECU 10-2 detects that there has been a loss of information or a loss of regularity in the received message as a result of the determination, and performs failsafe processing as a process of the ECU 10-2 (S213).

Then, the ECU 10-1 receives the response message from the ECU 10-2 (S112). Thus, the ECU 10-1 can detect that the ECU 10-2 is unable to receive the message normally.

When the ECU 10-2 detects an abnormality, that is, detects that there has been a loss of information or a loss of regularity in the received message, the ECU 10-2 limits a reception process after the abnormality is detected in S213. For example, the ECU 10-2 causes data received from a device that uses the same ID as that of the ECU 10-1 of the device on the transmission side in which the abnormality occurs (for example, a node 50 fraudulently using the same ID as that of the ECU 10-1) not to be used for the process of the ECU 10-2. For example, the ECU 10-2 discards the received message or replaces information indicated by the received message with a value different from a value indicated by the information and executes a process related to the received message.

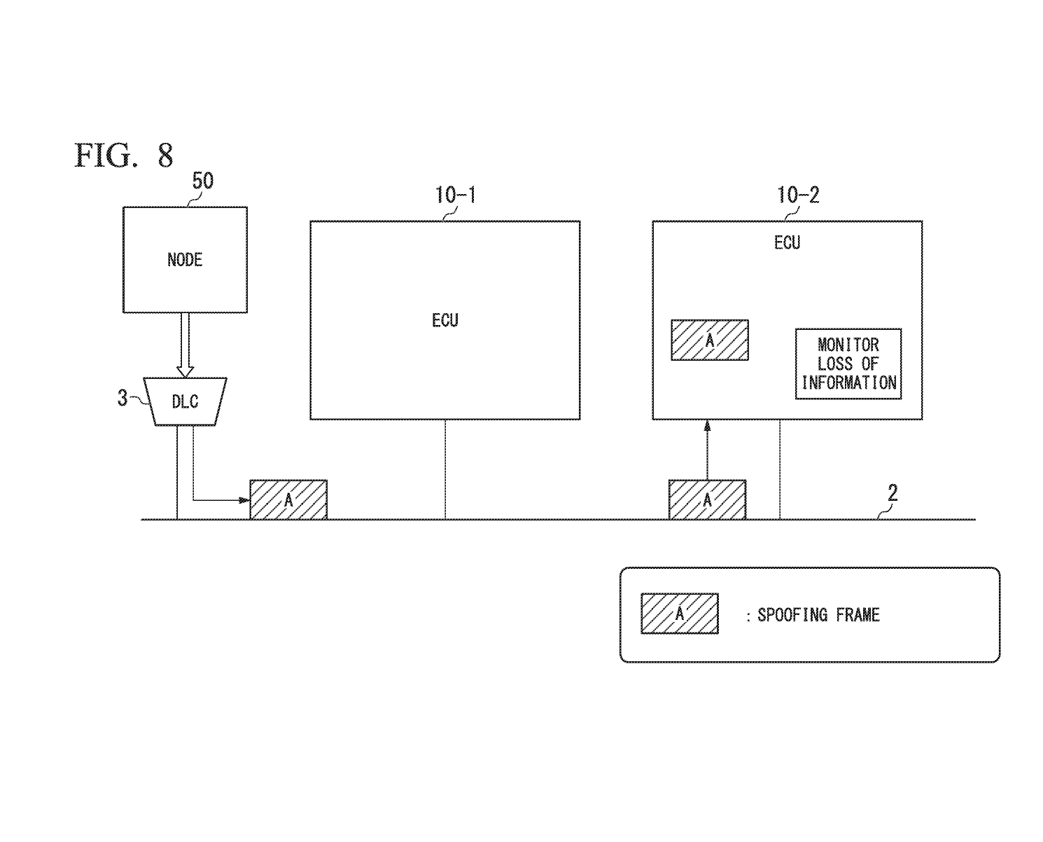

Next, a vehicle communication system in a case where fraudulent activity in the network NW is performed will be described with reference to FIGS. 8 to 12.

Here, a case where the node 50 that is not a regular external device is connected to the DLC 3 is illustrated. The node 50 performs fraudulent activity in the network NW such as spoofing, a DoS attack, or fraudulent access as fraudulent activity in the network NW. For example, the node 50 performs a process that is activated, for example, at a time of travel of the vehicle and has an influence on a process of the vehicle communication system 1.

Hereinafter, a case where spoofing has been performed as fraudulent activity in the network NW will be described.

A case where spoofing has been performed in the network NW related to a vehicle communication system of a comparative example is illustrated in FIG. 8. FIG. 8 is a diagram illustrating an operation of the vehicle communication system of the comparative example. The node 50 spoofs the ECU 10-1 and transmits a “spoofing frame A” to the ECU 10-2. The ECU 10-2 cannot identify a difference between a legitimate frame F and the spoofing frame A even when the ECU 10-2 receives the “spoofing frame A” and receives a message of the “spoofing frame A”. Since other ECUs 10 other than the ECU 10-2 cannot detect that the node 50 spoofing the ECU 10-1 is connected to the network NW, the vehicle communication system in the comparative example cannot reduce an influence of the spoofing of the node 50.

On the other hand, the ECU 10-1 in the vehicle communication system 1 of this embodiment detects that the node 50 spoofing the own ECU 10-1 is connected to the network NW.

Hereinafter, the EUC 10-1 will be described in detail.

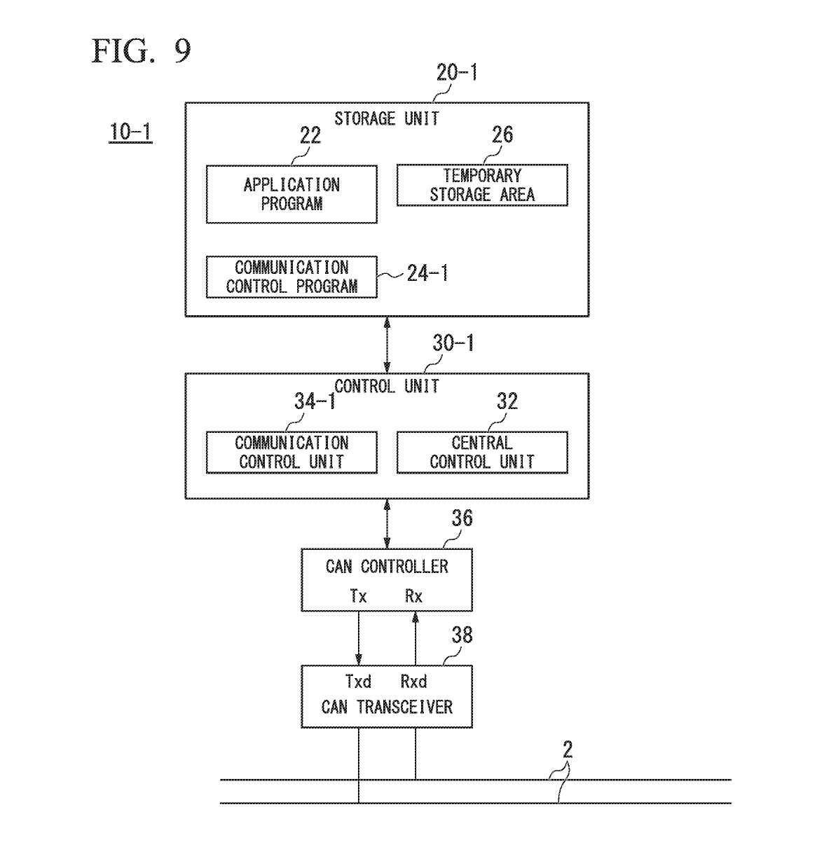

FIG. 9 is a diagram illustrating a configuration of the ECU 10-1 of this embodiment. The same configurations as in FIG. 2 are denoted with same reference numerals as the above reference numerals. A configuration denoted with the reference numeral “k−1” corresponds to the configuration denoted with the reference numeral “k” in FIG. 2.

The ECU 10-1 includes a storage unit 20-1, a control unit 30-1, the CAN controller 36, and the CAN transceiver 38. Hereinafter, a difference between the ECU 10-1 and the ECU 10 will be mainly described.

The storage unit 20-1 stores, for example, programs such as the application program 22 and a communication control program 24-1, and various types of information referenced by the above program.

The communication control program 24-1 includes the same program as the communication control program 24 and a program for executing a process of detecting that spoofing has been performed as fraudulent activity in the network NW. Details of the process of detecting spoofing will be described below.

The control unit 30-1 includes the central control unit 32 and a communication control unit 34-1.

The communication control unit 34-1 functions by executing the communication control program 24-1, and executes a communication process of the ECU 10-1 under the control of the central control unit 32. The communication control unit 34-1 performs both determinations as to whether spoofing has been performed and whether a received frame F is a frame F in which information to be used by the central control unit 32 of the own device is included by referring to a reception ID of a frame F received by the CAN transceiver 38 and a registration transmission ID of an ID table.

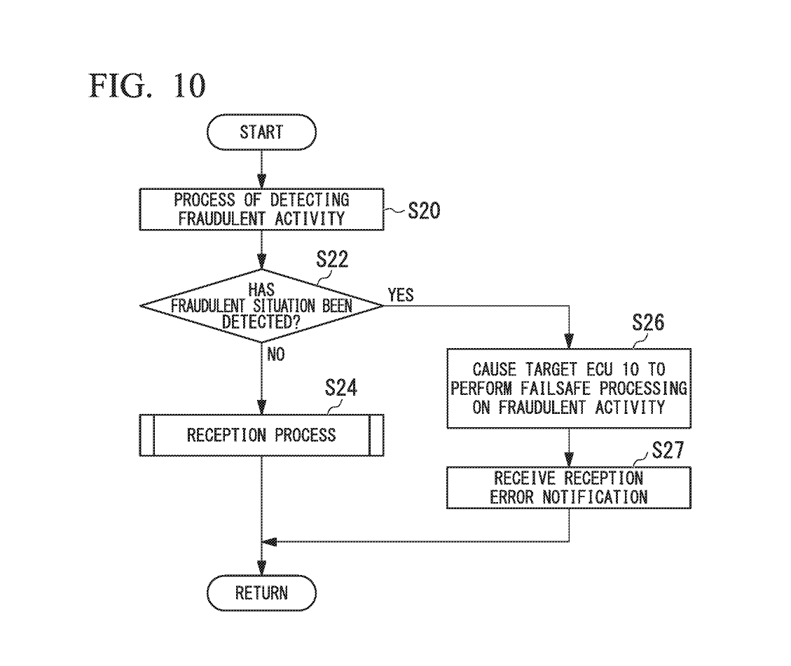

FIG. 10 is a flowchart illustrating an overview of a process that the ECU 10-1 performs when detecting fraudulent activity. The communication control unit 34-1 in the ECU 10-1 performs a predetermined process according to the following procedure.

First, the communication control unit 34-1 performs a process of detecting fraudulent activity in the network NW (spoofing in this embodiment) (S20). For example, the communication control unit 34-1 detects that a message to which an ID indicating that the ECU 10-1 is a transmission source has been added has been transmitted from another device other than the own ECU 10-1, and determines that fraudulent activity in the network NW, which is spoofing, has been performed.

In the determination, the communication control unit 34-1 uses the registration transmission ID among registration IDs stored in the ID table. The communication control unit 34-1 determines whether the received frame F is a frame F to which the reception ID having the same value as that of the registration transmission ID has been added to determine whether a fraudulent situation in the network NW has been detected, that is, whether spooling has been performed (S22).

When it is determined in the determination in S22 that spoofing has been performed (S22: Yes), the communication control unit 34-1 performs control to cause the other ECU 10 to perform failsafe processing on the fraudulent activity (S26).

For example, even when the communication control unit 34-1 detects fraudulent activity in the network as described above, the communication control unit 34-1 performs control to cause the other ECU 10 to perform the failsafe processing using the same method as in the case where the predetermined abnormality state has occurred. The communication control unit 34-1 generates a message in which the predetermined loss such as a loss of information or a loss of regularity has occurred as in the case where the predetermined abnormality state has occurred. The predetermined abnormality state includes, for example, a state in which the device fails or a state in which a process of the device is overloaded. The message in which the predetermined loss has occurred is a message in which values of at least some of all pieces of information included in the message are changed into other values so that the ECU 10-2 cannot determine that the message is a legitimate message. The information of which the value is changed by the ECU 10-1 so that the predetermined loss occurs does not include information such as an ID necessary to enable delivery of the message to the ECU 10-2. For example, the ECU 10-1 causes a loss to occur in information such as the update check information indicating that information or data used for error detection has been updated.

A more specific example is illustrated. The communication control unit 34-1 sets an error detection code such as a CRC a SUM value, and parity to be added to detect a transmission error of a message to be transmitted, to a value different from a legitimate value and generates a message in which the predetermined loss has occurred. Alternatively, the communication control unit 34-1 sets the update check information indicating that information included in the message and transmitted has been updated to a value different from the legitimate value and generates a message in which the predetermined loss has occurred.

The communication control unit 34-1 transmits the message in which the predetermined loss has occurred to the bus 2 via the CAN controller 36. Thus, the communication control unit 34-1 performs control so as to cause another ECU 10 selected as a destination, such as the ECU 10-2, to perform failsafe processing.

The ECU 10-2 receives the message in which the predetermined loss has occurred and performs the failsafe processing. The ECU 10-2 transmits a response message indicating a reception error to the ECU 10-1 in response to the reception of the message in which the predetermined loss has occurred.

Next, the communication control unit 34-1 receives the response message indicating a reception error from the ECU 10-2 (S27), detects that an error has been detected in the reception process in the ECU 10-2, and ends the process of the procedure shown in FIG. 10.

On the other hand, if spoofing is determined to have not been performed through the determination in S22 (S22: No), the communication control unit 34-1 performs a normal reception process including a process of determining whether failsafe processing of the own device is necessary on the received frame F (S24). For example, the communication control unit 34-1 performs processes from S11 to S16 in FIG. 4 described above. The communication control unit 34-1 causes the process of receiving the received message to be completed, and ends the procedure of the process illustrated in FIG. 10.

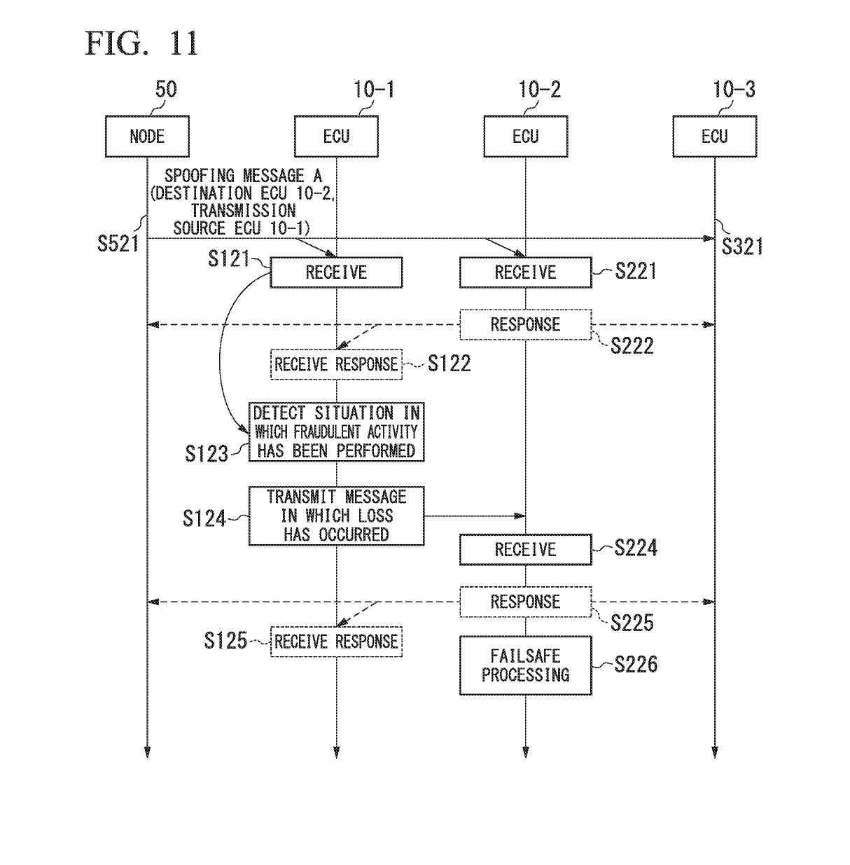

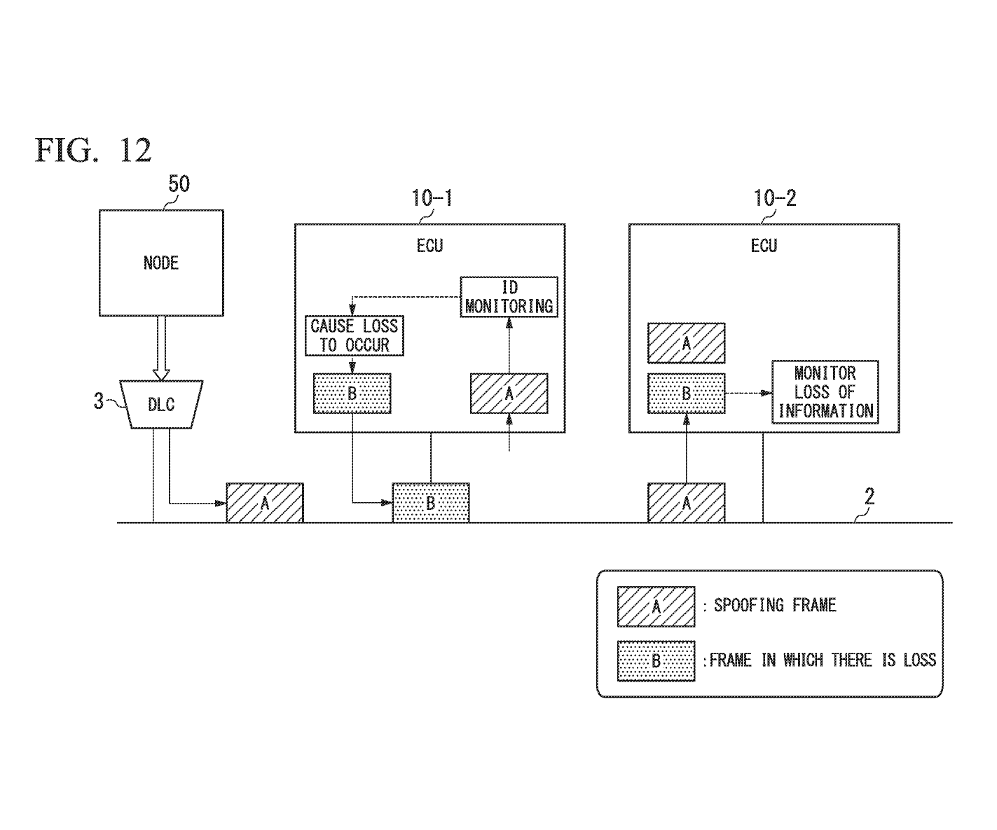

The vehicle communication system 1 that performs a spoofing countermeasure in the network NW will be described with reference to FIGS. 11 and 12. FIG. 11 is a sequence diagram illustrating an operation of the vehicle communication system 1 when spoofing has been performed. FIG. 12 is a diagram illustrating the operation of the vehicle communication system 1 when spoofing has been performed in the network NW.

As illustrated in FIG. 11, the node 50 spoofs the ECU 10-1, becomes a transmission source, and transmits a message addressed to the ECU 10-2 to the network NW (S521). It is seen from an ID of a frame F including the message (hereinafter referred to as a spoofing frame A) that the transmission source is the ECU 10-1 and a destination is the ECU 10-2. However, a true transmission source for the message is the node 50 and is not the ECU 10-1 as described above.

The message arrives at each ECU 10 connected to the network NW. The ECU 10-2 receives the message since the destination indicated by the ID of the spoofing frame A designates the own device (S221). The ECU 10-3 does not receive the message since the destination indicated by the ID of the spoofing frame A has a value different from a value indicating the own device (S321). On the other hand, the ECU 10-1 detects that an ID having a value indicating that the transmission source is the own device has been added to the spoofing frame A including the message, identifies that the message is a message in which a transmission source has been spoofed as a result of the detection, and receives the message (S121).

Next, the ECU 10-2 transmits a response message corresponding to the message transmitted from the node 50 to the network NW (S222). The ECU 10-1 receives the response message from the ECU 10-2 (S122). A process described below can be performed independently from the processes of S222 and S122, and the ECU 10-1 can perform the following process without waiting for S122 to complete.

Then, the ECU 10-1 determines that fraudulent activity in the network NW, which is spoofing, has been performed on the basis of the fact that the message received in S121 is a message in which the transmission source has been spoofed for the own ECU 10-1 (S123).

Then, the ECU 10-1 generates a message in which a predetermined loss has occurred similarly to the case where the own device is in the predetermined abnormality state and transmits a frame B including the generated message to the ECU 10-2 to cause the ECU 10-2 to perform failsafe processing (S124).

Then, the ECU 10-2 receives the message from the ECU 10-1 (S224) and performs a determination as to whether there is an abnormality in the received message. The ECU 10-2 detects that there is a loss in the received message and generates and transmits a response message to the message (S225). The ECU 10-2 may transmit the response message as a message for requesting retransmission.

Next, the ECU 10-1 receives the response message from the ECU 10-2 (S125). Thus, the ECU 10-1 can detect that the ECU 10-2 could not normally receive the message.

Further, the ECU 10-2 performs failsafe processing as the process of the ECU 10-2 based on the result of the determination (S226).

According to the first embodiment described above, the vehicle communication system 1 includes at least the ECU 10-1 and the ECU 10-2. The ECU 10-1 is connected to the network NW, and the predetermined loss occurs in a message that the ECU 101.

transmits to the network NW when the own ECU 10-1 is in the predetermined abnormality state. The ECU 10-2 is connected to the network NW and performs the predetermined failsafe processing when predetermined loss is detected in the message received from the network NW. Further, when the ECU 10-1 detects fraudulent activity in the network NW, the ECU 10-1 generates and transmits a message in which a predetermined loss has occurred similarly to the case where the own device is in the predetermined abnormality state. Accordingly, in the vehicle communication system 1, it is possible to reduce influence of fraudulent activity on the ECU 10 which is a fraudulent activity target and to protect the ECU 10 from fraudulent activity in the network NW with a simpler configuration.

### Second Embodiment

Hereinafter, a second embodiment will be described. In the second embodiment, a case where fraudulent activity in the network NW is a Denial of Service (DoS) attack will be described.

More specifically, the case where the vehicle communication system 1 performs a process against spoofing of the node 50 has been shown in the first embodiment whereas, instead of this, a vehicle communication system 1A of the second embodiment performs a process against a DoS attack of the node 50 as fraudulent activity. Hereinafter, this will be mainly described.

The vehicle communication system 1A includes an ECU 10-1A, the ECU 10-2, and the ECU 10-3. The ECU 10-1A corresponds to the ECU 10-1 of the first embodiment. The ECU 10-1 detects spoofing whereas, instead of this, the ECU 10-1A detects a DoS attack. The ECU 10-1A includes a storage unit 20-1A, a control unit 30-1A, the CAN controller 36, and the CAN transceiver 38. Hereinafter, a difference between the ECU 10-1A and the ECU 10-1 will be mainly described.

The storage unit 20-1A stores a program such as the application program 22 or a communication control program 24-1A, and various types of information referenced by the program.

The communication control program 24-1A includes the same program as the communication control program 24 and a program for executing a process of detecting that a DoS attack has been performed as fraudulent activity in the network NW. Details of the process of detecting a DoS attack will be described below.

The control unit 30-1A includes the central control unit 32 and a communication control unit 34-1A.

The communication control unit 34-1A functions by executing the communication control program 24-1A, and executes a communication process of the ECU 10-1A under the control of the central control unit 32. The communication control unit 34-1A determines whether a DoS attack has been performed on another ECU 10.

For example, the process of the ECU 10-1A will be described with reference to FIG. 10 described above.

The communication control unit 34-1A detects a reception situation of a response message corresponding to a message transmitted to the other ECU 10 as a process of detecting fraudulent activity in the network NW (S20). The communication control unit 34-1A determines whether fraudulent situation has been detected through the determination as to whether the response message corresponding to the message transmitted to the other ECU 10 is received within a predetermined time (S22). If the communication control unit 34-1A is unable to receive the response message within the predetermined time, the communication control unit 34-1A determines that the other ECU 10 to which the message is transmitted first is in a situation in which the other ECU 10 is unable to return the response message, and determines that a DoS attack is likely to have been performed on the other ECU 10. After the communication control unit 34-1A determines that the DoS attack which is a type of fraudulent activity in the network NW has been performed through the determination in S22 (S22: Yes), the communication control unit 34-1A performs the same process as that of the communication control unit 34-1 described above (S26 and S27).

On the other hand, if it is determined that the response message cannot be received within the predetermined time through the determination in S22 (S22: No), the communication control unit 34-1A determines that the other ECU 10 to which the message is transmitted first operates normally and a DoS attack on the other ECU 10 is not performed, and performs the same process as the process in S24 described above.

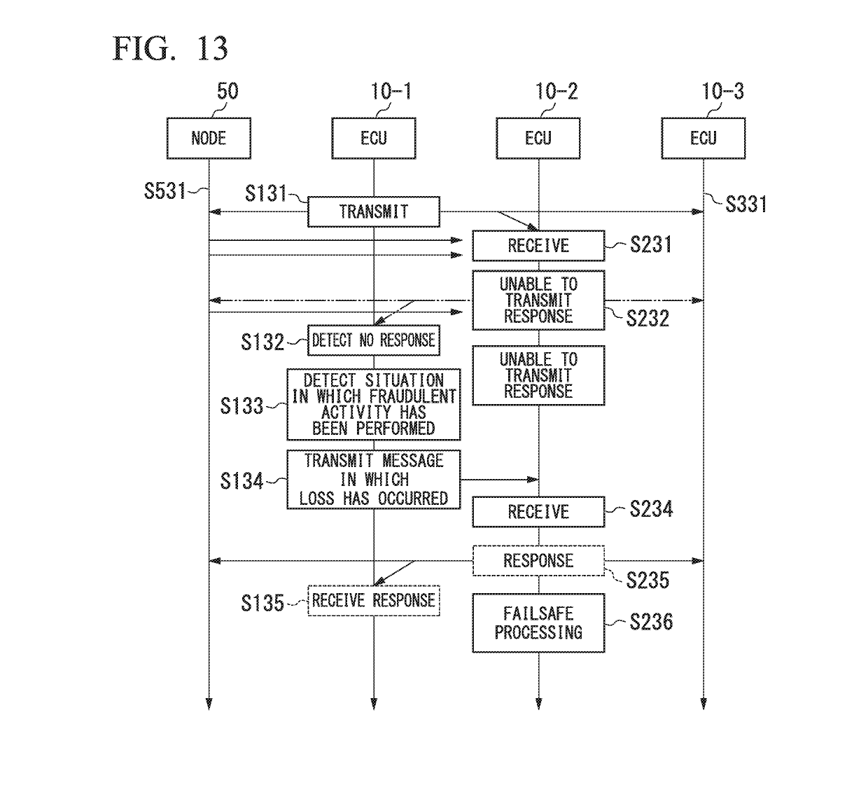

The vehicle communication system 1A that performs a DoS attack countermeasure on the network NW will be described with reference to FIG. 13. FIG. 13 is a sequence diagram illustrating an operation of the vehicle communication system 1A when a DoS attack is performed. In the following description, the node 50 is assumed to transmit a frame DoS for performing a DoS attack on the ECU 10-2 to the network NW.

As illustrated in FIG. 13, the ECU 10-1A transmits a message including an ID indicating that the message is a message addressed to the ECU 10-2 to the network NW (S131).

Then, the ECU 10-2 receives the message transmitted from the ECU 10-1A (S231) and tries to transmit a response message corresponding to the received message to the network NW (S231), but enters a situation in which the ECU 10-2 cannot transmit the response due to a DoS attack from the node 50 to the ECU 10-2 (S222).

Therefore, the ECU 10-1A waits for an arrival of the response message from the ECU 10-2 but cannot detect the response message within a predetermined time (S132). Accordingly, the ECU 10-1 determines that a DoS attack from the node 50 to the ECU 10-2 (fraudulent activity in the network NW) has occurred (S133).

Then, the ECU 10-1A generates a message in which a predetermined loss has occurred similarly to the case where the own device is in the predetermined abnormality state and transmits the message to the ECU 10-2 to cause the ECU 10-2 to perform failsafe processing (S134).

Next, the ECU 10-2 receives the message from the ECU 10-1A (S234) and performs a determination as to whether there is an abnormality in the received message. The ECU 10-2 detects that there is a loss in the received message and generates and transmits a response message to the message (S235). The ECU 10-2 may transmit the response message as a message for requesting retransmission.

Then, the ECU 10-1A receives the response message from the ECU 10-2 (S135). Thus, the ECU 10-1A can detect that the ECU 10-2 is unable to normally receive the message.

Further, the ECU 10-2 performs failsafe processing as a process of the ECU 10-2 based on the result of the determination (S236).

According to the second embodiment described above, in the vehicle communication system 1, the ECU 10-1A determines that fraudulent activity in the network NW has been detected by detecting that a predetermined amount of messages have been transmitted to the ECU 10 constituting the vehicle communication system 1. In the vehicle communication system 1, the ECU 10-1A that has detected that the process of the ECU 10-2 stopped due to a DoS attack causes the ECU 10-2 to perform failsafe processing so that a control state can be maintained as the safe state.

### Third Embodiment

Hereinafter, a third embodiment will be described. In the third embodiment, a case where fraudulent activity in the network NW is fraudulent access will be described. More specifically, the case where the vehicle communication system 1 performs a process against spoofing of the node 50 has been shown in the first embodiment whereas, instead of this, a vehicle communication system 1B of the third embodiment performs a process against fraudulent access of the node 50 to the ECU 10-1. For example, transmission of a message different from a legitimate message addressed to the own ECU 10 to the ECU 10 is included in fraudulent access. Hereinafter, this will be mainly described.

The vehicle communication system 1B includes an ECU 10-1B, the ECU 10-2, and the ECU 10-3. The ECU 10-1B corresponds to the ECU 10-1 of the first embodiment. The ECU 10-1 detects spoofing whereas, instead of this, the ECU 10-1B detects fraudulent access to the own device. The ECU 10-1B includes a storage unit 20-1B a control unit 30-1B, the CAN controller 36, and the CAN transceiver 38. Hereinafter, a difference between the ECU 10-1B and the ECU 10-1 will be mainly described.

The storage unit 20-1 stores a program such as the application program 22 or a communication control program 24-1B and various types of information referenced by the program.

The communication control program 24-1B includes the same program as the communication control program 24 and a program for executing a process of detecting fraudulent access has been performed as fraudulent activity in the network NW. Details of the process of detecting fraudulent access will be described below.

The control unit 30-1B includes the central control unit 32 and a communication control unit 34-1B.

The communication control unit 34-1B functions by executing the communication control program 24-1B, and executes a communication process of the ECU 10-1B under the control of the central control unit 32. The communication control unit 34-1B determines whether fraudulent access to a subsequent device has been performed.

For example, the process of the ECU 10-1B will be described with reference to FIG. 10 described above.

The communication control unit 34-1B compares an ID of an arriving frame F with a registration reception ID stored in an ID table of the storage unit 20 and detects that a fraudulent message for the own device has arrived as the process of detecting fraudulent activity in the network NW (S20). The communication control unit 34-1B determines whether a situation in which fraudulent activity (fraudulent access) has been performed has been detected by detecting that the fraudulent message for the own device has arrived (S22). The communication control unit 34-1B determines through the determination in S22 that fraudulent access which is a type of fraudulent activity in the network NW is likely to have been performed (S22: Yes). The communication control unit 34-1B performs control so that the own device performs failsafe processing on the fraudulent activity and performs control so that the ECU 10 that is a destination to which the own device transmits a message similarly performs failsafe processing on the fraudulent activity (S26).

For example, even when the communication control unit 34-1B detects fraudulent activity in the network as described above, the communication control unit 34-1B performs control to cause the ECU 10 that is destination to which the own device sends a message to perform the failsafe processing using the same method as in the case where the predetermined abnormality state has occurred.

Similarly to the method by the communication control unit 34-1 as described above, the communication control unit 34-1B generates a message in which the predetermined loss such as a loss of information or a loss of regularity has occurred as in the case where the predetermined abnormality state has occurred.

In subsequent process, the same process as in the communication control unit 34-1 described above is performed (S27).

On the other hand, when a fraudulent situation is not detected through the determination in S22 (S22: No), the communication control unit 34-1B determines that fraudulent access has not been performed and performs a process as the process of S24 described above.

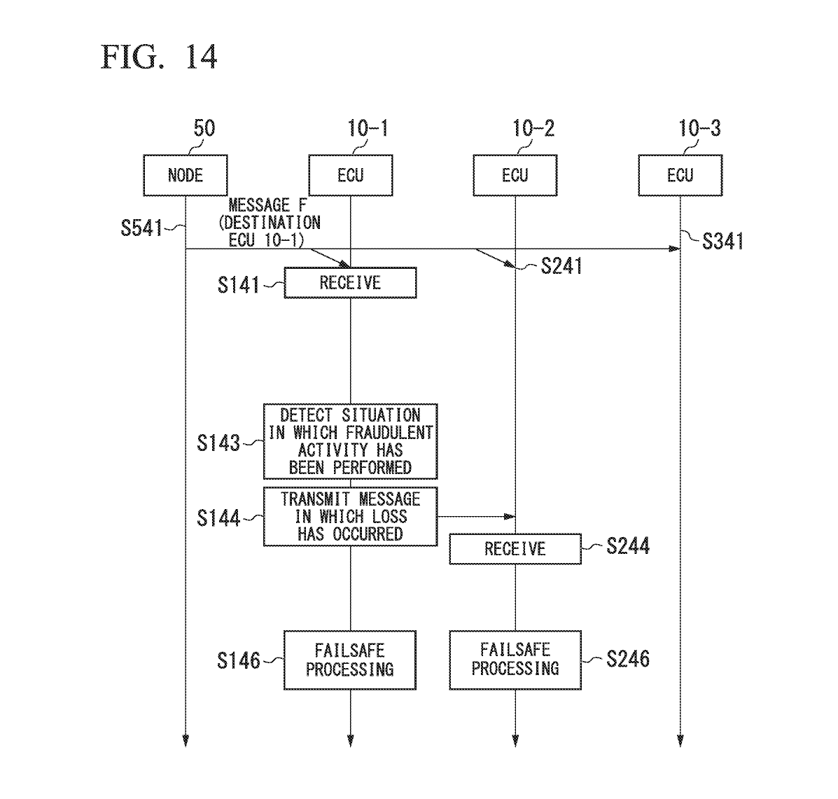

The vehicle communication system 1B that performs a fraudulent access countermeasure in the network NW will be described with reference to FIG. 14. FIG. 14 is a sequence diagram illustrating an operation of the vehicle communication system 1B in a case where fraudulent access has been performed.

As illustrated in FIG. 14, the node 50 transmits a frame F including a message for attempting fraudulent access to the ECU 10-1 to the network NW (S541). According to an ID of the frame F including the message at least a destination is the ECU 10-1.

The same message arrives at each ECU 10 connected to the network NW. Since the ECU 10-1 matches the destination indicated by the ID of the frame F, the ECU 10-1 receives the same message (S141). Since another ECU 10 is different from the destination indicated by the ID of the frame F, the other ECU 10 does not receive the same message (S241 and S341).

Then, the ECU 10-1 determines that fraudulent activity in the network NW that is fraudulent access has been performed on the basis of a detection indicating that the message received in S141 is a message for fraudulent access to the own ECU 10-1 (S143).

Then, the ECU 10-1 generates a message in which a predetermined loss has occurred similarly to the case where the own device is in the predetermined abnormality state and transmits a frame including the generated message to, for example, the ECU 10-2 to cause the other ECU 10 to perform failsafe processing (S144).

Next, the ECU 10-2 receives the message from the ECU 10-1 (S244) and performs a determination as to whether there is an abnormality in the received message. The ECU 10-2 detects that there is a loss in the received message and performs failsafe processing as a process of the ECU 10-2 based on a result of the detection (S226). Further, the ECU 10-1 performs failsafe processing in the own device (S146).

According to the third embodiment described above, in the vehicle communication system 1B, the ECU 10-1 detects that a message different from a legitimate message addressed to the own ECU 10-1 has been transmitted to the ECU 10-1 to determine that fraudulent activity in the network NW has been detected.

The method of detecting spoofing, the method of detecting a DoS attack, and the method of detecting fraudulent access are not limited to the above examples, and other methods may be used.

According to at least one embodiment described above, the communication system includes the transmission device and the reception device. The transmission device is connected to the network, and a message that the own device transmits to the network when the device is in the predetermined abnormality state is a message in which the predetermined loss has occurred.

The reception device is connected to the network, and performs the predetermined failsafe processing when the predetermined loss is detected in the message received from the network. The transmission device generates and transmits a message in which a predetermined loss has occurred similarly to the case where the own device is in the predetermined abnormality state even when the transmission device detects fraudulent activity in the network. Accordingly, the communication system can protect the control device from the fraudulent activity in the network using a simpler configuration.

In the above embodiment, the reception-side ECU 10 that has received a message in which a loss has occurred executes failsafe processing through the common process illustrated in FIG. 4 in any one of a case of a loss that has occurred due to a failure in the transmission-side ECU 10 and a case of a loss that has occurred due to a detection of fraudulent activity by the transmission-side ECU 10. Accordingly, in the vehicle communication system 1 (1A and 1B), it is not necessary for a determination process for performing failsafe processing to be added to the process of the ECU 10, and it is possible to protect the ECU 10 from fraudulent activity in a network with a simpler configuration.

Further, the ECU 10 serving as the reception device also has a detection function for abnormality detection or the like, and it is not necessary for a new message notifying that fraudulent activity in the network NW such as spoofing has been performed to be prepared as a message for communication between the ECUs 10. Further, the ECU 10 can deliver information indicating that fraudulent activity has been performed without adding a communication process for use of a new message in the notification of an abnormality to the process of the ECU 10. If a new message is used between the ECUs 10, it is necessary for the above communication process function to be added to each device related to the ECU 10 and the ECU 10. If manufacturers of the ECU 10 and the devices related to the ECU 10 are different from each other, an effort required from design to verification of the vehicle communication system 1 is necessary. However, in the vehicle communication system 1 of this embodiment, a complicated process as described above is not required.

From the viewpoint, the vehicle communication system 1 of this embodiment is capable of protecting a vehicle control device from fraudulent activity in a network using a simpler configuration.

Although the present invention has been described above with reference to the embodiments, the present invention is not limited to the embodiments, and various modifications and substitutions can be made without departing from the gist of the present invention.

What is claimed is:

1. A communication system, comprising:
a transmission device configured to be connected to a network, wherein a message to be transmitted to the network, in a case where an own device is in a predetermined abnormality state, becomes a message in which a predetermined loss has occurred; and
a reception device configured to be connected to the network and perform a predetermined failsafe processing when the predetermined loss has been detected in a message received from the network,
wherein the transmission device is configured to generate and transmit a message in which a predetermined loss has occurred similarly to the case where the own device is in the predetermined abnormality state when a fraudulent activity in the network has been detected.

2. The communication system according to claim 1,
wherein the transmission device is configured to detect that a device spoofing the own device is connected to the network as the fraudulent activity in the network.

3. The communication system according to claim 1,
wherein the transmission device is configured to detect that a message, to which an identifier indicating that the own device is a transmission source is added, is transmitted from another device, and to determine that the fraudulent activity in the network has been detected.

4. The communication system according to claim 1,
wherein the transmission device is configured to detect a DoS attack in the network as the fraudulent activity in the network.

5. The communication system according to claim 1,
wherein the transmission device is configured to detect a fraudulent access to the network as the fraudulent activity in the network.

6. The communication system according to claim 1,
wherein the transmission device is configured to set information for detecting a transmission error of the message to be transmitted to a value different from a legitimate value to generate the message in which the predetermined loss has occurred.

7. The communication system according to claim 1,
wherein the transmission device is configured to set information indicating that information to be transmitted by the message to be transmitted is updated to a value different from a legitimate value to generate the message in which the predetermined loss has occurred.

8. The communication system according to claim 1,
wherein the reception device is configured not to receive a message during a predetermined time after the predetermined loss has been detected in a message from the transmission device.

9. The communication system according to claim 1,
wherein, in a case where the reception device receives a message including an identifier indicating a transmission source as same as a transmission source of a message in which the predetermined loss has been detected during a predetermined time after the predetermined loss has been detected in the message from the transmission device, the reception device is configured not to use information included in the received message in a process in the reception device.

10. A control device that is configured to transmit a message to a reception device configured to perform a predetermined failsafe processing when a predetermined loss has been detected in a message received from a network, the control device comprising:
a control unit configured to be connected to the network, wherein a message to be transmitted to the network, in a case where an own device is in a predetermined abnormality state, becomes a message in which a predetermined loss has occurred, and generate and transmit a message in which a predetermined loss has occurred similarly to the case where the own device is in the predetermined abnormality state when a fraudulent activity in the network has been detected.

11. A method of controlling a communication system including a transmission device configured to be connected to a network, wherein a message to be transmitted to the network, in a case where an own device is in a predetermined abnormality state, becomes a message in which a predetermined loss has occurred, and a reception device configured to be connected to the network and perform a predetermined failsafe processing when the predetermined loss has been detected in a message received from the network, the method comprising:
a process of generating and transmitting a message in which a predetermined loss has occurred similarly to the case where the own device is in the predetermined abnormality state when a fraudulent activity in the network has been detected.
